(19) United States
(12) Patent Application Publication
(10) Pub. No.: US 2026/0329774 A1
(43) Pub. Date: Oct. 22, 2026

(54) SYSTEMS AND METHODS FOR CACHE MANAGEMENT FOR INTENSIVE COMPUTATION WITH SMALL DATA FRAMES

(71) Applicant: Microchip Technology Incorporated, Chandler, AZ (US)

(72) Inventors: Nian Niles Yang, Mountain View, CA (US); Pitamber Shukla, San Jose, CA (US); Ramyakanth Edupuganti, San Jose, CA (US)

(73) Assignee: Microchip Technology Incorporated, Chandler, AZ (US)

(21) Appl. No.: 19/302,958

(22) Filed: Aug. 18, 2025

Related U.S. Application Data
(60) Provisional application No. 63/789,674, filed on Apr. 16, 2025.

(51) Int. Cl. G06F 12/0862; G06F 12/121

(52) U.S. Cl. CPC G06F 12/0862; G06F 12/121

(57) ABSTRACT

A system comprises a host system and a data storage system. The data storage system includes a controller including at least one processor and computer readable media including volatile and non-volatile memory components. The computer readable media stores instructions that, when executed by the at least one processor, cause the at least one processor to: receive a prefetch data request from the host system, the prefetch data request including a physical block address (PBA) for a data segment; responsive to receiving the data request, retrieve the data segment from the non-volatile memory component by locating the data segment in the non-volatile memory using the PBA received from the host; and store the data segment in the volatile memory component.

### CROSS-REFERENCE TO RELATED APPLICATIONS

The current patent application claims the benefit under 35 U.S.C. § 119(e) of the priority date of U.S. Provisional Application Ser. No. 63/789,674; titled “SYSTEMS AND METHODS FOR CACHE MANAGEMENT FOR INTENSIVE COMPUTATION WITH SMALL DATA FRAMES”; and filed Apr. 16, 2025. The Provisional Application is hereby incorporated by reference, in its entirety, into the current patent application.

### TECHNICAL FIELD

Various examples of the present disclosure relate to cache management for intensive computation for small data frames.

### BACKGROUND

1. Data storage devices, such as solid state drives (SSDs), may include non-volatile memory (NVM) media (e.g., NAND-based memory media) for data storage, and typically include application-specific integrated circuitry (ASIC) controllers for managing read, write (or program), erase, and other operations. Data storage devices may be used in enterprise computing data center solutions (DCS) and certain high-performance computing (HPC) applications, such as artificial intelligence (AI). It is generally desirable to improve performance and/or reduce the cost of data storage devices, but it may be difficult to do so.

This background discussion is intended to provide information related to the present invention which is not necessarily prior art.

### SUMMARY OF THE INVENTION

According to various examples of the present disclosure, a data storage system comprises at least one processor and computer readable media including volatile and non-volatile memory components. The computer readable media stores instructions that, when executed by the at least one processor, cause the at least one processor to: receive a prefetch data request from a host system, the prefetch data request including a physical block address (PBA) for a data segment; responsive to receiving the data request, retrieve the data segment from the non-volatile memory component by locating the data segment in the non-volatile memory using the PBA received from the host system; and store the data segment in the volatile memory component.

According to various examples of the present disclosure, a data storage system comprises at least one processor and computer readable media including volatile and non-volatile memory components. The computer readable media stores instructions that, when executed by the at least one processor, cause the at least one processor to: receive a plurality of prefetch data requests from a host system, the plurality of prefetch data requests each corresponding to one of a plurality of corresponding data segments stored in the non-volatile memory component; responsive to receiving the plurality of prefetch data requests, generate a queue for retrieving the plurality of corresponding data segments ordered based on priority information; retrieve the respective data segments from the non-volatile memory component based on the queue; store the respective data segments in the volatile memory component; and responsive to a request from the host system, transmit at least one of the plurality of data segments from the volatile memory component to the host system.

According to various examples of the present disclosure, a system comprises a host system and a data storage system. The host system includes at least one processor and computer readable media storing instructions. The data storage system stores a plurality of data segments. The instructions, when executed by the at least one processor, cause the at least one processor to: maintain a list of PBAs of the plurality of data segments; project future data needs for one or more host operations; identify a data segment of the plurality of data segments based on the projected future data needs; retrieve a PBA of the plurality of PBAs corresponding to the identified data segment; and issue a prefetch command to the data storage system, the prefetch command including the PBA.

This summary is not intended to identify essential features of the examples, and is not intended to be used to limit the scope of the claims. These and other aspects of the present examples are described below in greater detail.

### BRIEF DESCRIPTION OF THE DRAWINGS

FIG. 1 illustrates an example system for small data frame cache management;

FIG. 2 illustrates an example computing system configured to perform operations in accordance with the various examples of the present disclosure;

FIG. 3 illustrates an example non-volatile memory (NVM) media in accordance with the various examples of the present disclosure;

FIG. 4 illustrates an example physical block of a data storage device in accordance with the various examples of the present disclosure;

FIG. 5 illustrates an example method for small data frame cache management;

FIG. 6 illustrates an example method for utilizing data queues in small data frame cache management;

FIG. 7 illustrates an example method for issuing data prefetch commands for small data frame cache management;

FIG. 8A illustrates an example method for small data frame cache management including operations performed by a host system and a data storage system; and

FIG. 8B illustrates further operations of the method of FIG. 8A.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

The term “signal” or “electronic signal” may be used to describe electrical energy conducted through an electrically conductive medium in which an electric voltage and/or an electric current varies, or may be constant, over time. An electronic signal may be an electromagnetic wave, voltage, and/or current, and may be encoded with or representative of information.

The term “electrically connected” may refer to components comprising conductor(s) such as terminals or contacts, with the conductor(s) of the respective electrically connected components being in electrical communication with one another via a pathway, the pathway typically comprising one or more conductor(s) such as metal(s) or metal alloy(s), optionally being interspersed with electronic component(s), and allowing the electrical communication via flow of electric current therebetween.

The phrase “responsive to” or “in response to” may refer to an operation performed directly in response to the occurrence of in part on a preceding operation and/or condition.

Various examples of the present disclosure may be used in single-level cell (SLC) systems, multi-level cell (MLC) systems, triple-level cell (TLC) systems, quad-level cell (QLC) systems, and penta-level cell (PLC) systems, without limitation. Applications may include consumer hard drives, high performance computing (HPC), data transfer for AI, and data center solutions (DCS), without limitation.

In various examples of the present disclosure, a data storage system may include a data storage component and a controller. The data storage component may include a non-volatile memory component storing data. The data storage system may additionally include a volatile memory component. The data storage system may be connected to a host system. The controller may be operable to manage storage and retrieval of data between the data storage component and the host system. Additionally, the controller may be operable to manage storage and retrieval of data between the volatile memory component and the host system.

In various examples of the present disclosure, the host system may retrieve data from the data storage system for one or more operations. The operation(s) may correspond to artificial intelligence (AI) and/or machine learning (ML) operations. The data may correspond to parameters (e.g., weights) for inference and/or training for AI/ML operations.

The host system may project future data needs for one or more operations to be performed at a future time. The host system may identify certain data segments to prefetch based on the projected future data needs. The identified data segments may be determined based at least in part on a probability that the identified data segments will be used for one or more future data operations or computations. In various examples each data segment may have a size of five hundred twelve (512) bytes or less. In various examples, each data segment may have a size of two hundred fifty-six (256) bytes or less. In various examples, each data segment may have a size of sixteen (16) kilobytes or less. For example, each data segment may have a data size of four (4) kilobytes or less.

The host system may keep track of physical block addresses (PBAs) for data segments stored in the data storage system. The host may send a prefetch request to the data storage system to prefetch the identified data segments. The prefetch request may include the PBA for each requested data segment. When the data is prefetched, the host system may directly access the data storage system to retrieve the prefetched data.

The data storage system may receive the prefetch request and retrieve the requested data segment(s) from the non-volatile memory component. The controller may identify the PBAs in the prefetch request and locate the requested data segments using the PBAs (e.g., without performing logical-to-physical (L2P) address conversion or referring to an L2P table). One or more of the requested data segments may be temporarily stored in the volatile memory of the data storage system. The host system may directly access the volatile memory component to retrieve the prefetched data when it is needed.

In this manner, some and/or all processing (e.g., L2P address conversion) that is typically performed by the controller of the data storage system before reading data from the non-volatile memory component may be bypassed and/or offloaded to the host system. Accordingly, the data storage system does not have to perform L2P address conversion, thereby reducing latency associated with reading the requested data and ensuring that critical data is easily and quickly accessible when it is needed. Moreover, where prefetched data is made available in volatile memory of the data storage system for direct access by the host, latency may further be reduced.

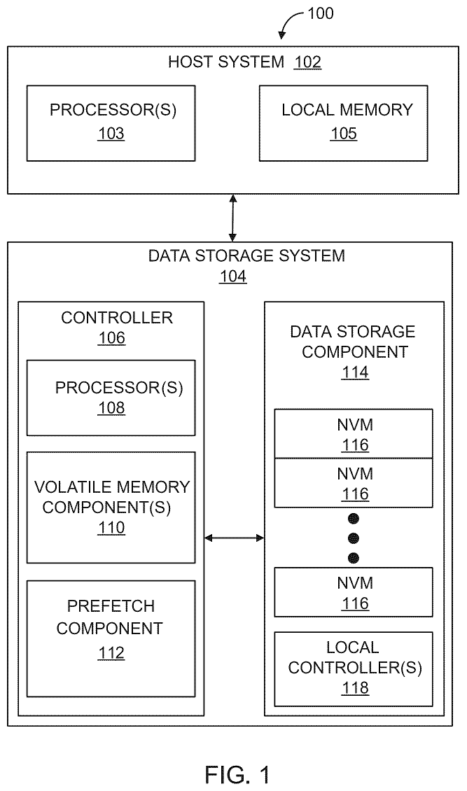

FIG. 1 illustrates an example system 100 including a host system 102 and a data storage system 104. The host system 102 includes at least one processor 103 and a local memory 105. The data storage system 104 includes a controller 106 and a data storage component 114. The controller 106 includes at least one processor 108, one or more volatile memory components 110, and a prefetch component 112. The data storage component 114 includes a plurality of non-volatile memory (NVM) 116 and one or more local controller(s) 118. The NVM 116 may individually or collectively be referred to as a non-volatile memory component.

In various examples, a read or write request may be received from the host system 102 via a peripheral component interconnect express (PCIe) interface that connects the data storage system 104 to servers or CPUs. PCIe is a standardized interface for motherboard components. In various examples, the data storage system 104 may be connected to the host system 102 by wired or wireless means (e.g., through a communications network). The data storage system 104 may be connected to more than one host system, such as in a multi-tenant environment, without limitation. Similarly, the host system 102 may be connected to more than one data storage system, without limitation.

During conventional operations, the controller 106 may use logical block addresses (LBAs) and PBAs to facilitate access for data storage in and retrieval from the NVM 116. LBAs are an abstraction to allow the operating system to interact with the NVM 116, and PBAs represent the actual hardware locations within the NVM 116. To facilitate interacting with the NVM 116, the controller 106 may create an entry or record that assigns an LBA to a PBA. To keep track of all such LBA-to-PBA assignments, the controller 106 may use a L2P mapping table. The L2P table may be sent to the host system 102 and uploaded to the local memory 105 so that it can be more quickly accessed by the host system 102.

When a data request is received from the host system 102, the controller 106 may determine whether the data request is a prefetch request. If the data request is not a prefetch request, or if the data request comprises a prefetch request that does not itself specify one or more PBAs for the requested data, the controller 106 references the L2P mapping table to determine the PBA within the NVM 116 corresponding to a desired LBA. Once the PBA is determined, the controller 106 accesses the appropriate NVM 116 to write or read the data. The controller 106 may employ an error correction code (ECC) operation during encoding and decoding data to detect and correct errors and enhance data integrity. If the data request is a prefetch request including one or more PBAs, the controller 106 uses the one or more PBAs included in the prefetch request to retrieve the requested data without referencing the L2P mapping table. The controller 106 may at least temporarily store the requested data in the volatile memory component(s) 110.

In various examples, the controller 106 and/or the data storage component 114 may support a direct memory access (DMA) operation enabling data to be written from the host system 102 directly to the NVM 116 and/or the volatile memory component(s) 110 and read from the NVM 116 and/or the volatile memory component(s) 110 directly to the host system 102. Certain commands may be issued to the controller 106 or the local controller(s) 118 using the host command layer, or non-volatile memory express management interface (NVMe-MI).

In various examples, the host system 102 may maintain a list of PBAs and/or the L2P mapping table corresponding to data segments stored in the NVM 116, thereby bypassing conventional L2P conversion to retrieve data from the NVM 116. Alternatively or additionally, the host system 102 may perform LBA to PBA conversions when requesting data from the data storage system 104, such that the controller 106 does not need to perform L2P conversion. The prefetch component 112 may identify PBAs for data segments stored in the NVM 116. In various examples, the controller 106 may send an update to the host system 102 when data is written to the NVM 116 and/or when data stored in the NVM 116 has an updated physical address. For example, the controller 106 may send the host system 102 updated PBAs following garbage collection operations, after writing new data to the NVM 116, periodically, and/or by request from the host system 102. The update may include updated PBAs for one or more data segments stored in the NVM 116. In some examples, the update may include an indication of the prefetched data segments stored in the volatile memory component(s) 110. The indication may identify the contents of the prefetched data segments, an amount of time the prefetched data segments have been stored in the volatile memory component(s) 110, and the like. In response to receiving the update, the host system 102 may update the list of PBAs and/or the L2P mapping table stored in the local memory 105.

In various examples, the host system 102 may determine to retrieve one or more prefetched data segments. The host system 102 may directly access the volatile memory component(s) 110 to retrieve the data from the volatile memory component(s). In some examples, the host system 102 may send a data request to the controller 106 for the prefetched data segment(s). In response to receiving the data request, the controller 106 may transmit the prefetched data segment(s) to the host system 102.

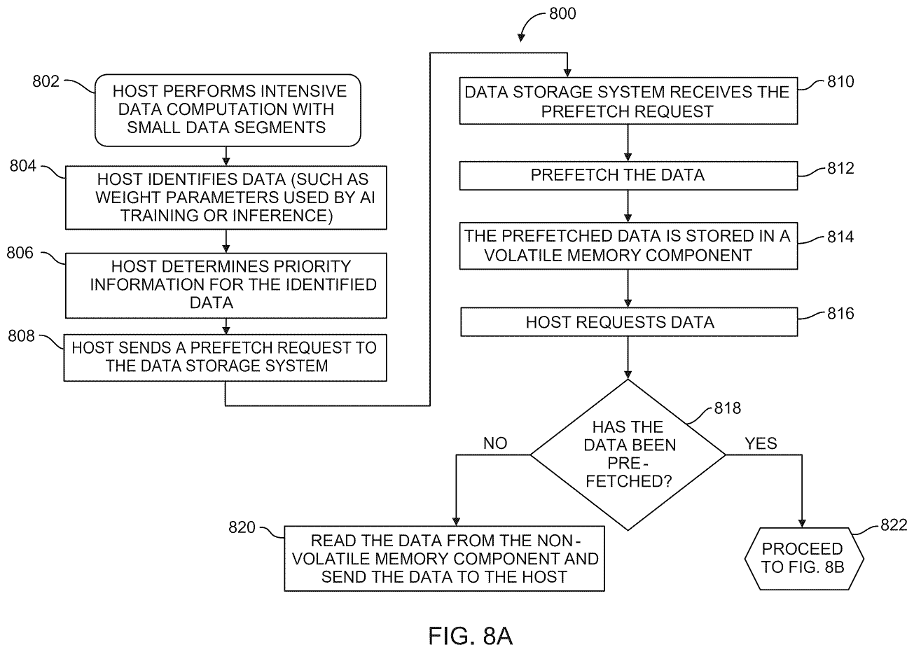

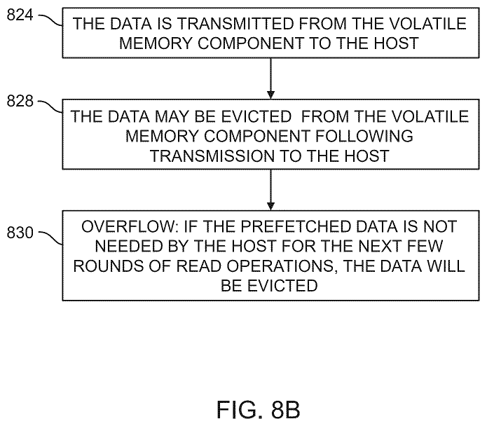

Moreover, the host system 102 may instruct the controller 106 to evict one or more prefetched data segments in response to receiving the update. In various examples, the host system 102 may also or alternatively issue eviction notifications or commands based on, for example, host system 102 computations of residence time of one or more of the prefetched data segments in the volatile memory component(s) 110, changes in the projected future data need(s) which initially led to storage of the one or more of the prefetched data segments in the volatile memory component(s) 110, and the like. In still other examples, the controller 106 may also or alternatively automatically evict data segments from the volatile memory component(s) 110 following retrieval of the prefetched data by the host system 102, after a predefined residence time elapses for the data segment(s) in the volatile memory component(s) 110, based on priority information included in one or more prefetch data requests, and/or according to a data queue or workload requirements, and the like. Additional details associated with prefetching data segments and evicting data segments are described below in connection with FIGS. 8A and 8B.

In various examples, the data storage system 104 may be a solid state drive (SSD), and the NVM 116 may be NAND-based flash memory. It would be appreciated by one of ordinary skill in the art that other memory devices (e.g., NOR flash memory, random access memory, and the like) may be utilized in the various examples described herein without departing from the spirit of the present disclosure.

In various examples, the controller 106 may receive a write request from the host system 102. The write request may include user data and/or parameters for one or more data operations to be written to one or more of the NVM 116 of the data storage component 114. The user data and/or parameters for the one or more data operations may include, for example, media (e.g., photos, videos, and/or audio), system information data, application data, sensor data, document data, recordkeeping data, machine learning/artificial intelligence data such as parameters and/or model weights, training data, inference data, gaming system data, data pertaining to internal operations of the host system, and the like, without limitation.

Following or in connection with the writing of the user data to the NVM 116, the controller 106 may identify one or more PBAs corresponding to physical locations of the written data. The controller 106 may send the updated PBAs to the host system 102.

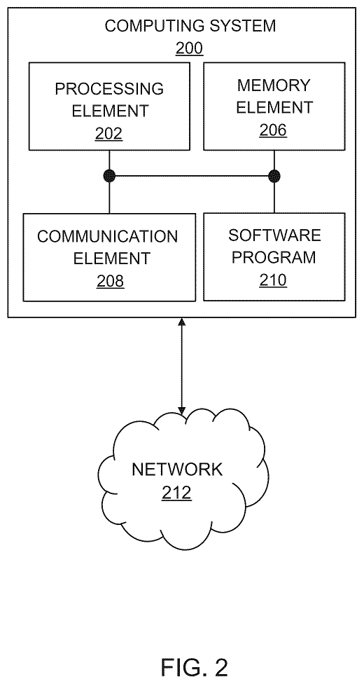

FIG. 2 illustrates a computing system 200 connected to a communication network 212. The computing system 200 may include at least one processing element 202, at least one memory element 206, a communication element 208, and a software program 210. In various examples, the computing system 200 may be a host system (e.g., the host system 102 of FIG. 1), a data storage system (e.g., the data storage system 104 of FIG. 1), and/or another computing device configured to perform some and/or all operations of the various examples of the present disclosure, without limitation.

The software program 210 may be configured with instructions for performing and/or enabling performance of at least some of the steps set forth herein. In an example, the software program 210 comprises instructions stored on computer-readable media of memory element 206. In various examples, the software program 210 may include instructions for performing operations of the prefetch component 112 discussed with reference to FIG. 1.

The communication network 212 generally allows communication between the computing system 200 and another computing device, such as between a remote host system, a local host system (e.g., the host system 102), and/or a data storage system (e.g., the data storage system 104 of FIG. 1), without limitation.

The communication network 212 may include the Internet, cellular communication networks, local area networks, metro area networks, wide area networks, cloud networks, plain old telephone service (POTS) networks, and the like, or combinations thereof. The communication network 212 may be wired, wireless, or combinations thereof and may include components such as modems, gateways, switches, routers, hubs, access points, repeaters, towers, and the like. The computing system 200 may, for example, connect to the communication network 212 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication element 208 generally allows communication between the computing system 200 and the communication network 212. The communication element 208 may include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are compatible with networking technologies such as ethernet. In certain examples, the communication element 208 may also couple with optical fiber cables. The communication element 208 may respectively be in communication with the processing element 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), solid state drives (SSDs), cache memory, hard disks, floppy disks, optical disks, flash memory, thumb drives, universal serial bus (USB) drives, or the like, or combinations thereof. In some examples, the memory element 206 may be embedded in, or packaged in the same package as, the processing element 202. The memory element 206 may include, or may constitute, a “computer-readable medium.” The memory element 206 may store the instructions, code, code segments, software, firmware, programs, applications, apps, services, daemons, or the like that are executed by the processing element 202. In various examples, the memory element 206 stores the software applications/program 210. The memory element 206 may also store settings, data, documents, sound files, photographs, movies, images, databases, and the like. In various examples, the memory element 206 may include a first memory component (e.g., the local memory 105 and/or the volatile memory component(s) 110 of FIG. 1) and one or more SSDs (e.g., the data storage component 114 of FIG. 1).

The processing element 202 may include electronic hardware components such as processors. The processing element 202 may include digital processing unit(s). The processing element 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 202 may generally execute, process, or run instructions, code, code segments, software, firmware, programs, applications, apps, processes, services, daemons, or the like. For instance, the processing element 202 may execute the software applications/program 210. The processing element 202 may also include hardware components such as finite-state machines, sequential and combinational logic, and other electronic circuits that can perform the functions necessary for the operation of the current disclosure. The processing element 202 may be in communication with the other electronic components through serial or parallel links that include universal busses, address busses, data busses, control lines, and the like.

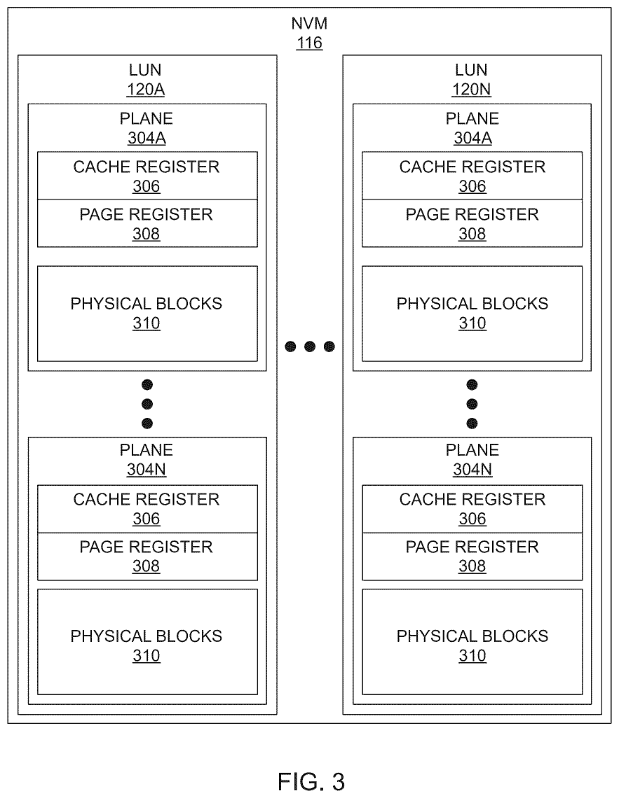

Turning to FIG. 3, the NVM 116 may respectively include a plurality of LUNs. As illustrated, the NVM 116 includes LUNs 120a, . . . 120n, where ‘a’ and ‘n’ are integers. As such, each NVM 116 may include, for example, two (2), four (4), six (6), eight (8), or more LUNs, without limitation. Each LUN 120a, . . . 120n may include a plurality of planes 304a, . . . 304n, again where ‘a’ and ‘n’ are integers. Each LUN 120a, . . . 120n may include, for example, four (4), six (6), eight (8), or more planes, without limitation.

Each plane may include a cache register 306, a page register 308, and a plurality of physical memory blocks 310. In various examples, the controller 106 may write incoming data to more than one NVM 116 in parallel. The NVM 116 may write incoming data to more than one LUN in parallel.

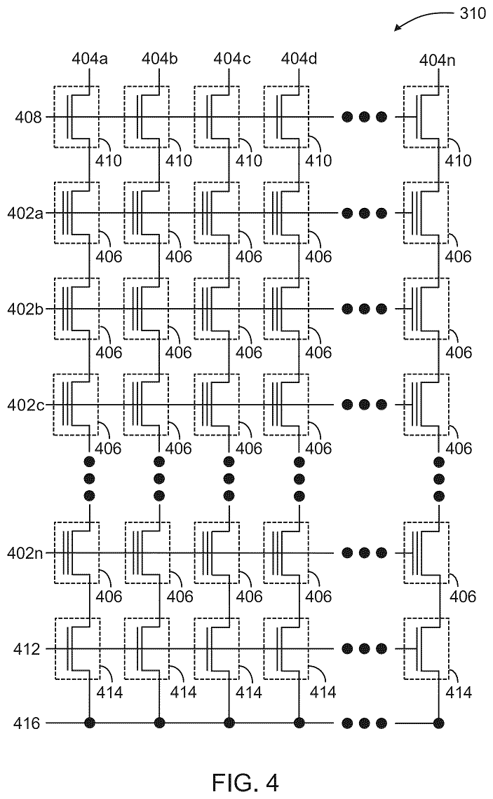

When data is written to or retrieved from the NVM 116, the data may be temporarily stored in one of the cache register 306 and/or the page register 308. Each physical memory block 310 may include a set of pages (as described in connection with FIG. 4 below). The cache register 306 and the page register 308 may respectively have an equivalent data capacity of one page. Accordingly, data to be written to a first page may be temporarily stored in the cache register 306 while data to be written to another page may be temporarily stored in the page register 308. Data to be read from a first page may be retrieved and temporarily stored in the cache register 306 while data to be read from another page may be stored in the page register 308. Accordingly, the cache register 306 and page register 308 enable double buffering of data to reduce data programming and read times.

Turning to FIG. 4, each of the physical memory blocks 310 includes a plurality of wordlines (WLs) 402a, 402b, 402c . . . 402n, a plurality of bit lines (BLs) 404a, 404b, 404c, 404d . . . 404n, and a plurality of cells 406. In various examples, a page may be defined as a row of cells connected to the same WL (e.g., the cells 406 connected to the WL 402a are collectively referred to as a page). Each page may include a plurality of cells 406. Each cell 406 may include a transistor having a gate, a source, and a drain. Data bits may be written to the cells 406 on a page-by-page basis. Data may be erased from the plurality of cells 406 on a physical memory block basis.

Generally, each WL is an electrical conductor that is electrically connected to control gates of the cells in a respective row of cells. Each WL may convey an electronic signal that, according to its voltage level, selects a row (or page) of cells. (Each WL 402a, 402b, 402c, . . . 402n may be drawn as a horizontal line shown in FIG. 4.) When a specific WL is activated (e.g., when a read voltage is applied), the cells connected to that WL are selected for reading or writing. In NAND flash memory, cells are organized into a series of strings, with each string being connected to one of a plurality of BLs, wherein each BL is an electrical conductor that is electrically connected to the drains of cells in a column of cells. Each BL may convey an electronic signal that, according to its voltage level, may enable data transfer to and from the cells of a selected WL during read and write operations. (Each BL 404a, 404b, 404c, 404d . . . 404n may be drawn as a vertical line shown in FIG. 4.) During a read operation, the voltage on the BL reflects a state of the selected cell(s). Accordingly, the voltage and/or current of the BL may be measured and/or determined to determine the value of the data in the selected cells.

In various examples, the cells 406 may include single-level cells (SLCs), multi-level cells (MLCs), triple-level cells (TLCs), quadruple-level cells (QLCs), and/or penta-level cells (PLCs), without limitation. Accordingly, the WLs 402a, 402b, 402c . . . 402n may be SLC wordlines, MLC wordlines, QLC wordlines and/or PLC wordlines, without limitation. In an example, a TLC wordline may include a lower page, a middle page, and an upper page. The lower page, middle page, and upper page may correspond to a page including a row of TLCs. The TLC wordline may be activated to write data to each of the upper, middle, and lower pages. Accordingly, an SLC wordline may include one (1) page, an MLC wordline may include two pages (2), a TLC wordline may include three (3) pages, a QLC wordline may include four (4) pages, and a PLC wordline may include five (5) pages.

The string select line 408 is an electrical conductor that is electrically connected to the gates of the string select transistors 410. The string select line 408 may convey an electronic signal that, according to its voltage level, selects one or more of the string select transistors 410. A BL bias voltage may be supplied to one or more of the BLs 404a, 404b, 404c, 404d, . . . 404n via the string select line 408. Similarly, the ground select line 412 is an electrical conductor that is electrically connected to the gates of the ground select transistors 414. The ground select line 412 may convey an electronic signal that, according to its voltage level, selects one or more of the ground select transistors 414. The string select transistors 410, when activated (e.g., by receiving a BL bias voltage), may connect a string (or column) of cells 406 to a corresponding one of the bitlines 404a, 404b, 404c, 404d, . . . 404n. The ground select transistors 414, when activated, may connect a string (or column) of cells 406 to the source line 416. The source line 416 is an electrical conductor that is electrically connected to the sources of the cells 406. The source line 416, in turn, may connect the string of cells to a common ground (or reference) voltage. The source line 416 may be connected to a sense amplifier (not shown), which may measure a string current (Icell) and/or voltage of the activated cells 406, thereby determining a value of the data stored in the activated cells 406.

Generally, a read voltage threshold may correspond to a reference voltage used when reading data from a cell. During a read operation, a read voltage may be applied to a WL corresponding to a page, or row of cells. In response to applying the read voltage, each cell may produce a current having a voltage value corresponding to a voltage threshold of that cell. The voltage threshold of the cells may be compared to the reference voltage to determine the value of the data in the cells. In the case of a triple-level cell (TLC), seven (7) different reference voltages are needed to read the three (3) bits stored in the TLC. Specifically, two (2) reference voltages may be used to read a first bit from the TLC, three (3) reference voltages may be used to read a second bit from the TLC, and two (2) reference voltages may be used to read a third bit from the TLC.

Returning to FIG. 1, the prefetch component 112 may process a plurality of prefetch requests received from the host system 102. Processing the prefetch requests may include parsing the prefetch requests to identify one or more PBAs corresponding to requested data segments and identifying priority information associated with the data segments. The priority information may include a probability that, and/or a timeframe within which, a particular data segment is to be used for one or more data operations.

The prefetch component 112 may generate a queue of prefetch requests. The prefetch component 112 may retrieve the requested data segments of the queued prefetch requests in order according to the queue. After the retrieved data is decoded and error corrected, the retrieved data may be stored in the volatile memory component(s) 110.

In various examples, the volatile memory component(s) 110 may include a first volatile memory component and a second volatile memory component. In various examples, the first volatile memory component may be a buffer random access memory (BRAM). The second volatile memory component may be a synchronous dynamic random access memory (SDRAM). The volatile memory component(s) 110 may additionally include a direct memory interface (DMI) and/or a DMA interface to support direct access to the volatile memory component(s) 110 by the host system 102.

In various examples, the first volatile memory component (e.g., BRAM) may be utilized for smaller (e.g., five hundred twelve (512) bytes or less) data segments that need to be transferred more quickly than larger (e.g., greater than five hundred twelve (512) bytes) data segments. Additionally or alternatively, the first volatile memory component may be utilized to temporarily store data segments having relatively higher priority (e.g., higher probability of being utilized within a predefined time period and/or more likely to be used for a particular upcoming data operation) than other data segments.

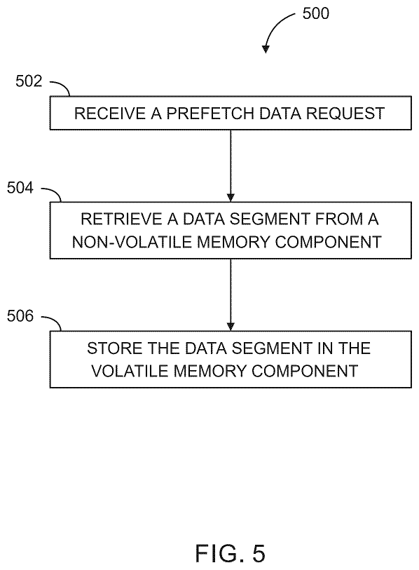

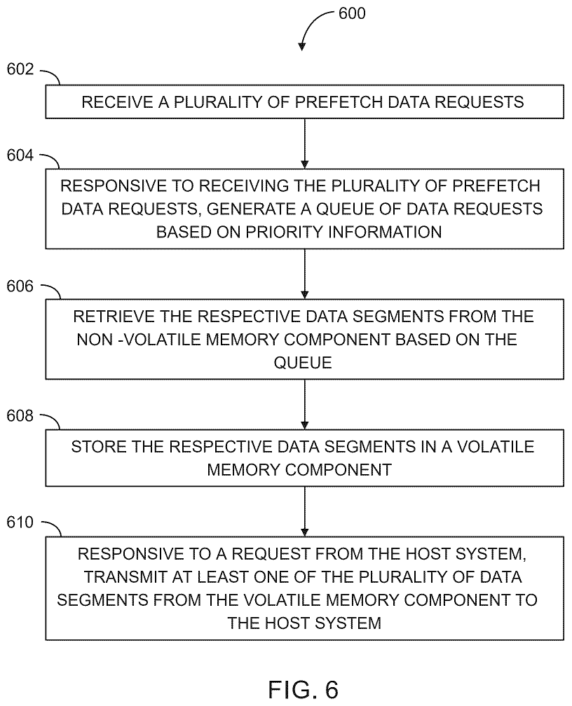

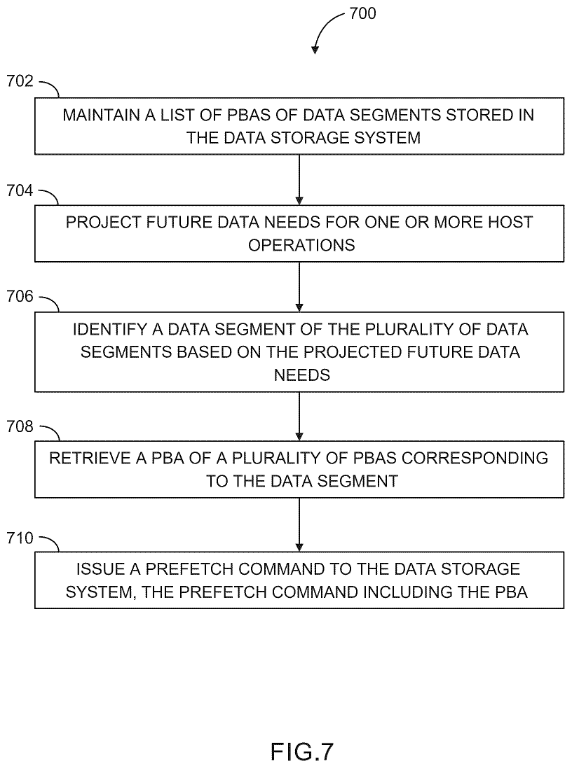

Additional operations and details associated with small data frame cache management are described in greater detail below in connection with the method 500 of FIG. 5, the method 600 of FIG. 6, the method 700 of FIG. 7, and the method 800 of FIGS. 8A and 8B. In various examples, the processor(s) 103, the processor(s) 108, and/or the prefetch component 112 may perform any and/or all operations described below with reference to FIGS. 5-7, 8A, and 8B.

In various examples, instructions for executing the prefetch component 112 may be stored in the volatile memory component(s) 110 and/or the NVM 116. Some or all functions of the prefetch component 112 may be executed by the processor(s) 108, the local controller(s) 118, other circuitry of the controller 106 and/or the data storage component 114, and/or a combination thereof.

Through hardware, software, firmware, or various combinations thereof, any of the processing elements (e.g., the processor(s) 103, the controller 106 and/or local controller(s) 118 of FIG. 1 and/or the processing element 202 of FIG. 2) may—alone or in combination with other processing elements—be configured to perform the operations of examples of the present disclosure. The examples described herein in connection with the attached drawing figures are intended to describe aspects of the disclosure in sufficient detail to enable those skilled in the art to practice the disclosure. Other examples can be utilized and changes can be made without departing from the scope of the present disclosure. The system may include additional, less, or alternate functionality and/or device(s), including those discussed elsewhere herein. The above and below detailed description is, therefore, not to be taken in a limiting sense. The scope of the present disclosure is defined only by the appended claims, along with the full scope of equivalents to which such claims are entitled, unless otherwise expressly stated and/or readily apparent to those skilled in the art from the description.

FIG. 5 illustrates an example method 500 for small data frame cache management. FIG. 6 illustrates an example method 600 for utilizing data queues in small data frame cache management. FIG. 7 illustrates an example method 700 for issuing data prefetch commands for small data frame cache management.

Each of the method 500 and the method 600 may be performed by a controller (e.g., the controller 106 and/or the prefetch component 112 of FIG. 1) of the data storage system. The method 700 may be performed by the host system connected to the data storage system. FIGS. 8A and 8B illustrate an example method 800 for small data frame cache management including operations performed by each of a host system (e.g., the host system 102 of FIG. 1) and a data storage system (e.g., the data storage system 104 of FIG. 1).

The data storage system may additionally include one or more volatile memory components (e.g., the volatile memory component(s) 110 of FIG. 1) and a data storage component (e.g., the data storage component 114 of FIG. 1). The data storage component may include a non-volatile memory component (e.g., the NVM 116 of FIG. 1).

In various examples, the operations of the method 500 may be performed in connection with the operations of the method 600, the operations of the method 700, and/or the operations of the method 800. The operations of the method 600 may be performed in connection with the operations of the method 500, the operations of the method 700, and/or the operations of the method 800. The operations of the method 800 may be performed in connection with the operations of the method 500, the operations of the method 600, and/or the operations of the method 700.

Turning to FIG. 5, at operation 502, a prefetch data request is received from the host system. The prefetch data request may include a PBA for a data segment of a plurality of data segments stored in the non-volatile memory component. The data segment may have a relatively small data size. The relatively small data size may be, for example, five hundred twelve (512) bytes or less.

At operation 504, the data segment is retrieved from the non-volatile memory component. The data segment may be retrieved by reading the data from the PBA of the non-volatile memory component identified in the prefetch data request (e.g., without performing L2P address conversion). The data segment may undergo decoding and error correction operations to ensure data integrity.

At operation 506, the data segment is temporarily stored in the volatile memory component(s). In various examples, a data request may be received from the host system. The data request include an identifier of the the data segment stored in the volatile memory component(s). The identifier may include ethe PBA for the data segment, an LBA for the data segment, or another identifier (e.g., a physical location within the volatile memory component(s)). In response to receiving the data request, the data segment may be transmitted to the host system.

The data segment may remain in the volatile memory component(s) until it is evicted. The data segment may be evicted from the volatile memory component following transmission of the data segment to the host system and/or based on a determination that the data segment meets one or more eviction criteria, as discussed in more detail below in connection with operations 828 and 830 of FIG. 8B.

In various examples, updated PBAs for one or more of the plurality of data segments may be determined. The updated PBAs may correspond to data segments that are newly stored in the non-volatile memory components and/or data segments associated with PBA changes (e.g., due to garbage collection operations). The updated PBAs to may be transmitted to the host system.

Turning to FIG. 6, in various examples, the data storage system may receive user data from the host system. The user data may be stored in the non-volatile memory as one or more of the plurality of corresponding data segments. The data storage system may transmit, to the host system, one or more PBAs corresponding to the one or more of the plurality of corresponding data segments. The host system may be configured to generate the corresponding one of the plurality of prefetch requests to include the one or more PBAs.

In various examples, updated PBAs for one or more data segments may be determined. The updated PBAs may correspond to data segments that are newly stored in the non-volatile memory components and/or data segments associated with PBA changes (e.g., due to garbage collection operations). The updated PBAs to may be transmitted to the host system.

At operation 602, a plurality of prefetch data requests are received from the host system. Each of the prefetch data requests may include one or more PBAs and priority information for requested data segments. The PBAs may identify respective ones of the requested data segments. The priority information may include a probability that the each of the requested data segments are to be utilized for one or more upcoming host operations, a timeframe within which such utilization is expected to be realized, or other priority information.

At operation 604, a queue of data requests is generated based on the priority information. The queue may include respective PBAs included in the prefetch data requests. The generation of the queue may be responsive to receipt of one or more of the requests, may be performed in response to receipt of each request on a rolling basis, or otherwise without departing from the scope of the present examples. Data segments having a higher priority may be placed higher in the queue than others of the requested data segments. Alternatively or additionally, the queue may be generated based on an order in which the prefetch requests are received. In various examples, the queue may represent a hybrid approach, such as where the queue is nominally based on an order of receipt, but certain high priority requests may be advanced to earlier positions based on the priority information.

In various examples, the queue may include a first queue and a second queue. The first queue may correspond to a first portion of the requested data segments to be stored in a first volatile memory component (e.g., BRAM) of the volatile memory component(s). The second queue may correspond to a second portion of the requested data segments to be stored in a second volatile memory component (e.g., SDRAM) of the volatile memory component(s). The first portion of the data segments may have a relatively smaller data size (e.g., five hundred twelve bytes (512) or less) and/or have a higher priority than the second portion of the data segments (e.g., having a data size of greater than five hundred twelve (512) bytes).

At operation 606, the respective data segments are retrieved from the non-volatile memory component in order based on the queue. Higher priority ones of the respective data segments may be retrieved prior to retrieving lower priority ones of the respective data segments, according to the queue.

At operation 608, the respective data segments are temporarily stored in the volatile memory component(s). The first portion of the respective data segments may be stored in the first volatile memory component. The second portion of the respective data segments may be stored in the second volatile memory component.

At operation 610, in response to a request from the host system, at least one of the plurality of the data segments is transmitted from the volatile memory component(s) to the host system. The request may identify one or more of the data segments stored in the volatile memory component(s). The identified data segment(s) may be directly accessed by the host system through a DMA interface and/or may be transmitted by the data storage system to the host system. The request may include one or more of an indication that all data stored in the volatile memory component(s) is requested, identifiers for a subset of the plurality of data segments, or an identifier for one of the plurality of data segments.

In various examples, the identified data segment(s) may be evicted from the volatile memory component(s) following transmission of the identified data segment(s) to the host system and/or based on a determination that the identified data segment(s) meets one or more eviction criteria, as discussed in more detail below in connection with operations 828 and 830 of FIG. 8B.

Turning to FIG. 7, at operation 702, a list of a plurality of PBAs of data segments stored in the data storage system is maintained. Maintaining the list of PBAs may include identifying updates to the PBAs of data segments and updating the list of PBAs. The host system may receive updated PBAs from the data storage system periodically, when new data is stored in the data storage system, and/or when the PBA for one or more data segments changes (e.g., following garbage collection operations).

The list of PBAs may be stored within a local memory of the host system (e.g., the local memory 105 of FIG. 1) as its own data entry and/or may be stored as part of an L2P mapping table. In various examples, the data storage system may send LBAs to the host system, and the host system may identify PBAs associated with the LBAs by referencing the L2P mapping table and performing a L2P address conversion. The L2P address conversion may be performed each time the host system receives updated LBAs and/or PBAs and/or may be performed when identifying data to request from the data storage system. In an alternative example, L2P conversion may be performed by the data storage system (e.g., when a prefetch request received from the host system does not include a PBA).

At operation 704, future data needs for one or more host operations are projected. The host system may identify one or more ongoing host operations and/or upcoming operations. The future data needs may include parameters for one or more AI/ML operations (e.g., weights for training and/or inference operations). The host system may identify the parameters that may be utilized for the AI/ML operations for the ongoing and/or upcoming host operation(s).

Predicting the future data needs may include determining respective priority information for a plurality of data segments. The priority information may include a priority value (e.g., a percentage) representing a probability that a particular one of the plurality of data segments is to be used for the ongoing and/or upcoming host operation(s) and/or represent an urgency for such use(s). The respective priority information may additionally identify a type of data stored in each data segment (e.g., training data or inference data).

The priority value for the respective data segments may be determined based on historical data usage, a type of host operation being performed or to be performed, a data type, and the like. The historical data usage may include information associated with previously utilized data segments for one or more host operations, such as how often the previously used data segments were utilized, when the previously used data segments were most recently utilized, and/or one or more host operations in which the previously used data segments were utilized, and the like.

At operation 706, a data segment of the plurality of data segments is identified based on the projected future data needs. The identified data segment may include one or more of the parameters that may be utilized for the AI/ML operations. The host system may determine that the data segment is stored in the non-volatile memory component and is likely to be utilized for the ongoing and/or upcoming host operation(s).

At operation 708, a PBA of the plurality of PBAs corresponding to the data segment is retrieved. The host system may identify the PBA by referring to the list of PBAs and/or by identifying an LBA for the data segment and converting the LBA to the PBA using the L2P mapping table. In various examples, for example where prefetch command at operation 710 omits a PBA, operation 708 may be omitted.

At operation 710, a prefetch command is issued to the data storage system. The prefetch command may include the PBA or other identifying information for the data segment. The prefetch command may additionally include the priority information for the data segment.

Following issuance of the prefetch command, the corresponding data segment may be stored in the volatile memory component(s), for example according to the method(s) 500 and/or 600. The host system may determine that the data segment is needed imminently for an ongoing host operation. The host system may retrieve the data segment from the volatile memory component (e.g., through a DMA interface). Accordingly, the host system may quickly retrieve the data segment when it is needed for the ongoing host operation.

In various examples, the host system may determine that the data segment meets one or more eviction criteria, as discussed in more detail below in connection with operations 828 and 830 of FIG. 8B. The eviction criteria may include an amount of time the data segment has been stored in the volatile memory component(s), the priority information associated with the data segment, or a request based on the projected future data needs. The host system may determine, based on the projected future data needs, that the data segment meets the one or more eviction criteria and send a request to evict the data segment in response to the determination.

In various examples, the host system may identify additional ones of the plurality of data segments based on the future data needs. The host system may retrieve additional ones of the plurality of PBAs respectively corresponding to the additional ones of the plurality of data segments. The host system may issue a plurality of additional prefetch commands to the data storage system. The additional prefetch commands may include the respective additional ones of the plurality of PBAs and respective priority information for the additional ones of the plurality of data segments. The priority information may include respective probabilities that the additional ones of the plurality of data segments are to be used for one or more host operations and/or indicators or timeframes for the urgency of such operation(s).

Turning to FIG. 8A, at operation 802, the host may perform intensive data computations with relatively small (e.g., five hundred twelve (512) bytes or less) data segments. The intensive data computations may be associated with one or more AI/ML operations, such as inference, training, and the like. The data computations may utilize data segments having a relatively small size (e.g., five hundred twelve (512) bytes or less) compared to other data operations that utilize relatively larger data segments (e.g., greater than five hundred twelve (512) bytes).

At operation 804, the host may identify data that may be used in one or more upcoming host operations. The identified data may include data that may be used for one or more data operations to be performed at a future time. The identified data may include weight parameters for AI/ML operations. The identified data may include a plurality of data segments having varying data sizes. For example, a first data segment may have a data size of one hundred twenty eight (128) bytes, a second data segment may have a data size of two hundred fifty six (256) bytes, and a third data segment may have a data size of five hundred twelve (512) bytes.

The host system may identify PBAs for the identified data segments. The PBAs may be determined based on a list or table of PBAs stored locally in the host system. Alternatively or additionally, the host system may store an L2P mapping table and identify the PBAs by identifying LBAs for the identified data segments and performing L2P address conversion. The list of PBAs and/or the L2P mapping table may be received from the data storage system and may be updated periodically, when new data is stored in the non-volatile memory component, and/or when PBAs for one or more data segments is updated (e.g., following garbage collection operations).

At operation 806, the host may determine priority information for the identified data segments. The priority information may include a respective probability that each data segment is to be used in one or more upcoming host operations and/or indicators or timeframes for the urgency of such operation(s). The probability may include, for example, a value (e.g., a percentage) determined by the host system based on projecting future data needs, as discussed in connection with operation 704 of the method 700 of FIG. 7.

At operation 808, the host may send a prefetch request to the data storage system. The prefetch request may include one or more PBAs for each identified data segment. The prefetch request may additionally include the priority information for each identified data segment.

At operation 810, the data storage system receives the prefetch request from the host system. The data storage system may parse the prefetch request to identify PBAs of the requested data segments and the priority information for each of the requested data segments. The data storage system may generate a queue of data requests based on the priority information and/or based on an order of receipt of the request(s), as discussed in connection with operation 604 of the method 600 of FIG. 6.

At operation 812, the data storage system may prefetch the requested data. The data may be prefetched in order based on the queue, as discussed in connection with operation 606 of the method 600 of FIG. 6.

At operation 814, the requested data may be stored in the volatile memory component(s). A first portion of the requested data may be stored in a first volatile memory component (e.g., BRAM) of the volatile memory component(s). A second portion of the requested data may be stored in a second volatile memory component (e.g., SDRAM). The first portion of the requested data may have a smaller data size and/or a higher priority than the second portion of the requested data.

At operation 816, the host system may send a data request to the data storage system. The data request may identify one or more data segments that are to be used in an upcoming or currently ongoing host operation. The data request may include PBAs for the requested data segments.

At operation 818, the data storage system may determine whether the requested data has been prefetched. If the data storage system determines that the requested data has not been prefetched, the method 800 continues to operation 820. At operation 820, the data storage system may read the requested data from the non-volatile memory component using the PBAs included in the data request and transmit the requested data to the host system. If the data storage system determines that the requested data has been pre-fetched, the method 800 continues to operation 822 and proceeds to FIG. 8B.

Turning to FIG. 8B, at operation 824, the requested data is extracted from the volatile memory component(s) and transmitted to the host system. As described with reference to FIG. 1, the volatile memory component(s) may include a DMA interface to enable the host to directly access and retrieve the requested data from the volatile memory component(s).

At operation 828, the requested data may be evicted from the volatile memory component(s) following transmission of the requested data to the host system. Following eviction of the data, the data storage system may store a next round of prefetched data in the volatile memory component(s). The next round of prefetched data may correspond to data identified by one or more additional prefetch requests and may be stored in the volatile memory component(s) based on an order in which the prefetch requests were received and/or in order of priority indicated in the prefetch requests. In various examples, the data storage system may refer to the queue to identify the next round of prefetched data to store in the volatile memory component(s).

In various examples, the host system may request to evict data stored in the volatile memory component(s). For example, the host system may determine that previously prefetched data will not be needed for any upcoming host operations. In response to the determination, the host system may instruct the data storage system to evict the previously prefetched data from the volatile memory component(s). Additionally, the host system may request to keep one or more prefetched data segments in the volatile memory component(s) even after the prefetched data segments are sent to the host system (e.g., where the host system determines that the data segments may be utilized in multiple different upcoming host operations and/or used more than once in the same host operation).

At operation 830, an overflow process may be performed. The overflow process may be performed by either the host system or the data storage system. The overflow process may include determining whether prefetched data meets one or more eviction criteria. The eviction criteria may include whether the prefetched data will be needed by the host system for one or more upcoming host operations, an amount of time the prefetched data has been stored in the volatile memory, an amount of available volatile memory, relative priority information associated with the prefetched data and any queued prefetch data requests (e.g., newly requested data may have a higher priority than previously prefetched and aged data segments), and/or based on a request from the host system.

In various examples, one or both of the operations 828 and 830 may be performed following execution of operation 820 without departing from the scope of the present disclosure.

### Feature Combinations

According to various examples of the present disclosure, a data storage system may comprise at least one processor and computer readable media including volatile and non-volatile memory components. The computer readable media may store instructions that, when executed by the at least one processor, cause the at least one processor to: receive a prefetch data request from a host system, the prefetch data request including a PBA for a data segment; responsive to receiving the data request, retrieve the data segment from the non-volatile memory component by locating the data segment in the non-volatile memory using the PBA received from the host system; and store the data segment in the volatile memory component.

According to various examples of the present disclosure, a data storage system may comprise at least one processor and computer readable media including volatile and non-volatile memory components. The computer readable media may store instructions that, when executed by the at least one processor, cause the at least one processor to: receive a plurality of prefetch data requests from a host system, the plurality of prefetch data requests each corresponding to one of a plurality of corresponding data segments stored in the non-volatile memory component; responsive to receiving the plurality of prefetch data requests, generate a queue for retrieving the plurality of corresponding data segments ordered based on priority information; retrieve the respective data segments from the non-volatile memory component based on the queue; store the respective data segments in the volatile memory component; and responsive to a request from the host system, transmit at least one of the plurality of data segments from the volatile memory component to the host system.

According to various examples of the present disclosure, a host system may comprise at least one processor and computer readable media storing instructions. The data storage system may store a plurality of data segments. The instructions, when executed by the at least one processor, may cause the at least one processor to: maintain a list of PBAs of a plurality of data segments stored on a data storage system; project future data needs for one or more host operations; identify a data segment of the plurality of data segments based on the projected future data needs; retrieve a PBA of the plurality of PBAs corresponding to the identified data segment; and issue a prefetch command to the data storage system, the prefetch command including the PBA.

In combination with any of the previous examples, instructions, when executed by at least one processor, may cause the at least one processor to: receive, from a host system, a data request for a data segment stored in a volatile memory component; and transmit the data segment from the volatile memory component to the host system.

In combination with any of the previous examples, a data segment may have a data size of five hundred twelve (512) bytes or less.

In combination with any of the previous examples, instructions, when executed by at least one processor, may cause the at least one processor to: determine one or more updated PBAs for one or more of a plurality of data segments; and transmit, to a host system, the one or more updated PBAs.

In combination with any of the previous examples, a volatile memory component may comprise a BRAM.

In combination with any of the previous examples, a volatile memory component may comprise an SDRAM.

In combination with any of the previous examples, instructions, when executed by at least one processor, may cause the at least one processor to: determine a data segment stored in a volatile memory component meets one or more eviction criteria; and evict the data segment from the volatile memory component based on the determination.

In combination with any of the previous examples, one or more eviction criteria may include one or more of: an amount of time a data segment has been stored in a volatile memory component, priority information associated with the data segment, or a request from a host system.

In combination with any of the previous examples, a volatile memory component may comprise a first volatile memory component and a second volatile memory component. Instructions, when executed by at least one processor, may cause the at least one processor to: store a first data segment of respective data segments in the first volatile memory component; and store a second data segment of the respective data segments in the second volatile memory component.

In combination with any of the previous examples, a first data segment may have a higher priority than a second data segment.

In combination with any of the previous examples, a first data segment may have a smaller data size than a second data segment.

In combination with any of the previous examples, instructions, when executed by at least one processor, may cause the at least one processor to: receive user data from a host system; store the user data in a non-volatile memory component as one of a plurality of corresponding data segments; and transmit, to the host system, one or more PBAs corresponding to the one of the plurality of corresponding data segments. The host system may be configured to generate a corresponding one of a plurality of prefetch requests to include the one or more PBAs.

In combination with any of the previous examples, a data storage system may comprise a volatile memory component accessible by a host system. An identified data segment may be stored in the volatile memory component following issuance of a prefetch command. Instructions, when executed by at least one processor, may cause the at least one processor to: retrieve, from the volatile memory component of the data storage system, the identified data segment.

In combination with any of the previous examples, a data storage system may comprise a volatile memory component accessible by a host system. An identified data segment may be stored in the volatile memory component following issuance of a prefetch command. Instructions, when executed by at least one processor, may cause the at least one processor to: determine the identified data segment meets one or more eviction criteria; and responsive to the determination, send, to the data storage system, a request to evict the data segment from the volatile memory component.

In combination with any of the previous examples, one or more eviction criteria may include one or more of: an amount of time a data segment has been stored in a volatile memory component, priority information associated with the data segment, or a request based on projected future data needs.

In combination with any of the previous examples, instructions, when executed by at least one processor, may cause the at least one processor to: identify additional ones of a plurality of data segments based on projected future data needs; retrieve additional ones of a plurality of PBAs respectively corresponding to the additional ones of the plurality of data segments; and issue a plurality of additional prefetch commands to a data storage system. The additional prefetch commands may include the respective additional ones of the plurality of PBAs and respective priority information for the additional ones of the plurality of data segments.

In combination with any of the previous examples, priority information may include respective probabilities that additional ones of a plurality of data segments are to be used for one or more host operations.

### General Considerations

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A data storage system, comprising:
at least one processor; and
computer readable media including volatile and non-volatile memory components, the computer readable media storing instructions that, when executed by the at least one processor, cause the at least one processor to
receive a prefetch data request from a host system, the prefetch data request including a physical block address (PBA) for a data segment;
responsive to receiving the data request, retrieve the data segment from the non-volatile memory component by locating the data segment in the non-volatile memory using the PBA received from the host system; and
store the data segment in the volatile memory component.

2. The data storage system of claim 1, wherein the instructions, when executed by the at least one processor, cause the at least one processor to:
receive, from the host system, a data request for the data segment stored in the volatile memory component; and
transmit the data segment from the volatile memory component to the host system.

3. The data storage system of claim 1, wherein the data segment has a data size of five hundred twelve (512) bytes or less.

4. The data storage system of claim 3, wherein the instructions, when executed by the at least one processor, cause the at least one processor to:
determine one or more updated PBAs for one or more of the plurality of data segments; and
transmit, to the host system, the one or more updated PBAs.

5. The data storage system of claim 1, the volatile memory component comprising a buffer random access memory (BRAM).

6. The data storage system of claim 1, the volatile memory component comprising a synchronous dynamic random access memory (SDRAM).

7. The data storage system of claim 1, wherein the instructions, when executed by the at least one processor, cause the at least one processor to:
determine the data segment stored in the volatile memory component meets one or more eviction criteria; and
evict the data segment from the volatile memory component based on the determination.

8. The data storage system of claim 7, the one or more eviction criteria including one or more of: an amount of time the data segment has been stored in the volatile memory component, priority information associated with the data segment, or a request from the host system.

9. A data storage system, comprising:
at least one processor; and
computer readable media including volatile and non-volatile memory components, the computer readable media storing instructions that, when executed by the at least one processor, cause the at least one processor to
receive a plurality of prefetch data requests from a host system, the plurality of prefetch data requests each corresponding to one of a plurality of corresponding data segments stored in the non-volatile memory component;
responsive to receiving the plurality of prefetch data requests, generate a queue for retrieving the plurality of corresponding data segments ordered based on priority information;
retrieve the respective data segments from the non-volatile memory component based on the queue;
store the respective data segments in the volatile memory component; and
responsive to a request from the host system, transmit at least one of the plurality of data segments from the volatile memory component to the host system.

10. The data storage system of claim 9,
the volatile memory component comprising a first volatile memory component and a second volatile memory component, wherein the instructions, when executed by the at least one processor, cause the at least one processor to:
store a first data segment of the respective data segments in the first volatile memory component; and
store a second data segment of the respective data segments in the second volatile memory component.

11. The data storage system of claim 10, the first data segment having a higher priority than the second data segment.

12. The data storage system of claim 10, the first data segment having a smaller data size than the second data segment.

13. The data storage system of claim 9, wherein the instructions, when executed by the at least one processor, cause the at least one processor to:
determine one or more updated PBAs for one or more of the plurality of data segments; and
transmit, to the host system, the one or more updated PBAs.

14. The data storage system of claim 9, wherein the instructions, when executed by the at least one processor, cause the at least one processor to:
receive user data from the host system;
store the user data in the non-volatile memory component as one of the plurality of corresponding data segments; and
transmit, to the host system, one or more physical block addresses (PBA) corresponding to the one of the plurality of corresponding data segments, the host system being configured to generate the corresponding one of the plurality of prefetch requests to include the one or more PBAs.

15. A host system, comprising:
at least one processor; and
computer readable media storing instructions that, when executed by the at least one processor, cause the at least one processor to
maintain a list of physical block addresses (PBAs) of a plurality of data segments stored on a data storage system;
project future data needs for one or more host operations;
identify a data segment of the plurality of data segments based on the projected future data needs;
retrieve a PBA of the plurality of PBAs corresponding to the identified data segment; and
issue a prefetch command to the data storage system, the prefetch command including the PBA.

16. The host system of claim 15, the data storage system comprising a volatile memory component accessible by the host system, the identified data segment being stored in the volatile memory component following issuance of the prefetch command, wherein the instructions, when executed by the at least one processor, cause the at least one processor to:
retrieve, from the volatile memory component of the data storage system, the identified data segment.

17. The host system of claim 15, the data storage system comprising a volatile memory component accessible by the host system, the identified data segment being stored in the volatile memory component following issuance of the prefetch command, wherein the instructions, when executed by the at least one processor, cause the at least one processor to:
determine the identified data segment meets one or more eviction criteria;
responsive to the determination, send, to the data storage system, a request to evict the data segment from the volatile memory component.

18. The host system of claim 17,
the one or more eviction criteria including one or more of: an amount of time the data segment has been stored in the volatile memory component, priority information associated with the data segment, or a request based on the projected future data needs.

19. The host system of claim 15, wherein the instructions, when executed by the at least one processor, cause the at least one processor to:
identify additional ones of the plurality of data segments based on the projected future data needs;
retrieve additional ones of the plurality of PBAs respectively corresponding to the additional ones of the plurality of data segments; and
issue a plurality of additional prefetch commands to the data storage system, the additional prefetch commands including the respective additional ones of the plurality of PBAs and respective priority information for the additional ones of the plurality of data segments.

20. The host system of claim 19, wherein the priority information includes respective probabilities that the additional ones of the plurality of data segments are to be used for the one or more host operations.
